(19) United States
(12) Patent Application Publication
(10) Pub. No.: US 2006/0228024 A1
(43) Pub. Date: Oct. 12, 2006

(54) Method for adjusting an image sensor

(75) Inventors: Matthias Franz, Tuebingen (DE); Steffen Fritz, Wurmberg (DE); Karsten Haug, Stuttgart (DE)

Correspondence Address: KENYON & KENYON LLP, ONE BROADWAY, NEW YORK, NY, 10004, US

(73) Assignee: koninklijke phillips electronics n.v.

(21) Appl. No.: 10/542,672

(22) PCT Filed: Nov. 12, 2003
(86) PCT No.: PCT/DE03/03744

§ 371 Date: Apr. 12, 2006

(30) Foreign Application Priority Data
Jan. 17, 2003 (DE) 10301898.0

(51) Int. Cl. G06K 9/00

(52) U.S. Cl. 382/169

(57) ABSTRACT

A method and a processing unit for adjusting the characteristic curve of the exposure sensitivity of at least one pixel of at least one image sensor in a motor vehicle are described. The optimal characteristic curve of the exposure sensitivity is determined from the histogram of the gray values of at least one image as a function of image signals from at least one image sensor. The freely definable characteristic curve of the image sensor having linear segments is chosen so that it agrees at least approximately with the optimal characteristic curve. Along with the size and/or the position of the characteristic curve of the exposure sensitivity, alternatively or in addition the shape of the characteristic curve is adjusted.

### FIELD OF THE INVENTION

The present invention relates to a method and a processing unit for adjusting the characteristic curve of the exposure sensitivity of an image sensor, the image sensor being located in particular in a motor vehicle.

### BACKGROUND INFORMATION

Outdoor scenes often have a broad range of different radiation intensities. In particular in traffic scenes in the motor vehicle field, frequently a great difference in radiation intensities occurs. This becomes clear for example when a motor vehicle approaches a tunnel entrance in daylight. While the surroundings of the motor vehicle outside the tunnel are bright in the sunlight, often only weak lighting is found in the tunnel itself. With the plan to equip motor vehicles with image sensors which register the surroundings of the motor vehicle, it is desirable for the image sensors to process this wide range of different radiation intensities. In the conventional regulation of an image sensor, the image sensor is adapted to the lighting conditions through appropriate choice of the parameters of gain, offset, integration time, and/or aperture. In newer developments of image sensors, the exposure sensitivity does not follow a rigidly set linear or logarithmic characteristic curve, but rather the characteristic curve may be adjusted individually in particular in single linear segments. For example, a CMOS image sensor having an adjustable characteristic curve with linear segments is discussed in U.S. Pat. No. 6,348,681, Reference to a method and a processing unit for attaining high information content of generated images is lacking in U.S. Pat. No. 6,348,681.

### SUMMARY OF THE INVENTION

The method described below for adjusting the characteristic curve of the exposure sensitivity of at least one pixel of at least one image sensor has the advantage that the generated image information has high information content and a broad dynamic range. The method described below is particularly advantageous in outdoor use of the at least one image sensor, since outdoors a plurality of different radiation intensities may occur simultaneously in a scene. In particular, the method described below is suitable for use in a motor vehicle, since with this method, for example, sections of streets which are in full sunlight and simultaneously have areas of shadow may be mapped with high information content of the image information. In an advantageous manner, the method described below utilizes the additional degrees of freedom of a characteristic curve of the exposure sensitivity having segments of functions, in particular continuous and/or linear functions, so that the at least one image sensor captures a maximum of information in its images about the scene being mapped at that time.

It is advantageous to approximate the characteristic curve of the exposure sensitivity to the optimal characteristic curve of the exposure sensitivity through at least one numerical approximation method and/or at least one segmenting method. In particular, approximation through at least one segmenting method has the advantage that the at least one segmenting method contributes to a simple implementation of the method on a microprocessor.

Particularly advantageous is adjustment of the characteristic curve of the exposure sensitivity, the characteristic curve being formed in segments of linear functions. Characteristic curves of the exposure sensitivity having segments of linear functions contribute to the characteristic curves being easily realizable in the image sensor, and also enable a simple algorithmic implementation of the method described below in the processing unit.

It is advantageous to adjust the characteristic curve of the exposure sensitivity of at least one pixel of at least one image sensor as a function of image signals from at least two image sensors, in particular from at least one stereo camera which is made up of at least two sensors. This procedure has the advantage that by averaging the image signals the precision and robustness of the method for adjusting the exposure sensitivity of at least one pixel of at least one image sensor is increased.

The described advantages apply correspondingly to the method described below and/or the processing unit described below and/or the computer program described below.

A computer program having a program code arrangement for carrying out all the steps, or at least the essential steps of the described method, when the program is executed on a computer, is advantageous. The use of a computer program facilitates quick and cost-effective adaptation of the method, for example to different image sensors.

Additional advantages derive from the following description of exemplary embodiments with reference to the figures.

### BRIEF DESCRIPTION OF THE DRAWINGS

FIG. 1 shows a diagram with characteristic curves of the exposure sensitivity of an image sensor.

FIG. 2 shows a diagram with characteristic curves of the exposure sensitivity of an image sensor as a function of the gain and the offset.

FIG. 3 shows a block diagram of an exemplary embodiment.

### DETAILED DESCRIPTION

A method and a processing unit for adjusting the characteristic curve of the exposure sensitivity of at least one pixel of at least one image sensor in a motor vehicle are described below. In an exemplary embodiment, the optimal characteristic curve of the exposure sensitivity is determined from the histogram of the gray values of at least one image as a function of image signals from at least one image sensor. The freely definable characteristic curve of the image sensor having linear segments is chosen so that it agrees at least approximately with the optimal characteristic curve. Along with the size and/or the position of the characteristic curve of the exposure sensitivity, alternatively or in addition the shape of the characteristic curve is adjusted.

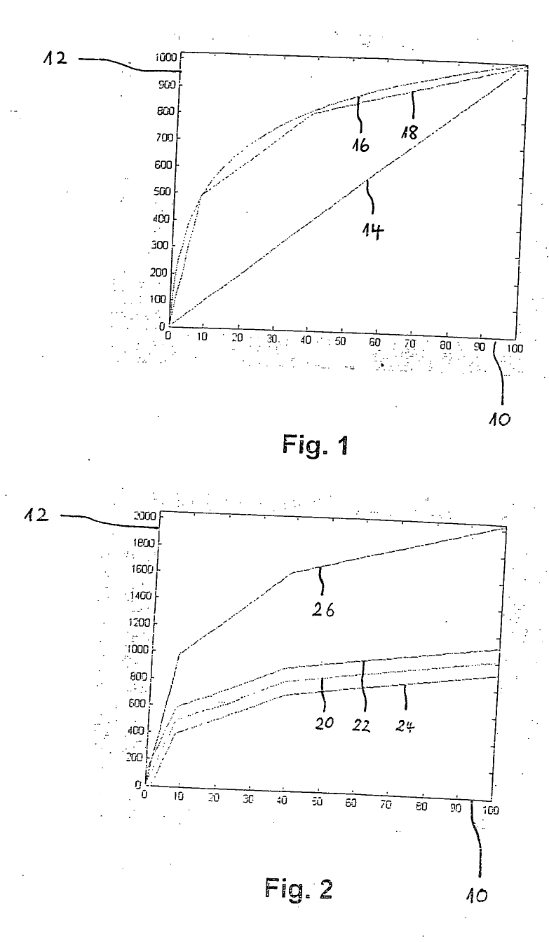

FIG. 1 shows a diagram with three characteristic curves 14, 16, 18 of the exposure sensitivity of a pixel of an image sensor. Exposure 10 is plotted on the abscissa. Exposure 10 is plotted here in freely defined, virtual units of 0 to 100, exposure 10 being for example a measure of the radiation intensity or the illumination intensity. Here the radiation intensity is a physical value which indicates the radiation power per unit area, while the illumination intensity is the corresponding photometric value using the unit lux, which takes into account the spectral sensitivity of the human eye. Output signal 12 of the pixel of the image sensor is plotted on the ordinate as a freely defined, virtual unit from 0 to 1000. Output signal 12 may be present as a digital signal or an analog signal. As a first form of the characteristic curve of the exposure sensitivity, a linear characteristic curve 14 of the exposure sensitivity is plotted in FIG. 1. The diagram in FIG. 1 also shows a logarithmic characteristic curve 16 of the exposure sensitivity and a characteristic curve 18 of the exposure sensitivity in linear segments.

FIG. 2 shows a diagram with four characteristic curves 20, 22, 24, 26 of the exposure sensitivity in linear segments of a pixel of an image sensor as a function of the gain and/or the offset. Corresponding to FIG. 1, exposure 10 is plotted on the abscissa in freely defined, virtual units from 0 to 100. Output signal 12 of the pixel of the image sensor is plotted on the ordinate as a freely defined, virtual unit from 0 to 2000. In first characteristic curve 20 of the exposure sensitivity, the gain is 1 and the offset 0. In contrast, in second characteristic curve 22 of the exposure sensitivity the offset has a value of +100, while in third characteristic curve 24 of the exposure sensitivity it has a value of −100. In both second characteristic curve 22 of the exposure sensitivity and third characteristic curve 24 of the exposure sensitivity, the gain is 1. In fourth characteristic curve 26 of the exposure sensitivity, the gain is 2 with an offset of 0. A change in the offset shifts the characteristic curve of the exposure sensitivity in the ordinate direction, while a change in the gain and/or a change in the integration time expands or compresses the characteristic curve of the exposure sensitivity in the ordinate direction. A freely configurable characteristic curve of the exposure sensitivity in linear segments, such as for example first characteristic curve 20 of the exposure sensitivity in FIG. 2, results in more degrees of freedom when adjusting at least one pixel of the image sensor, since here single segments can be adjusted individually. Along with the size and position of characteristic curve 20, 22, 24, 26 of the exposure sensitivity, this makes it alternatively or additionally possible to change the shape of characteristic curve 20, 22, 24, 26 of the exposure sensitivity.

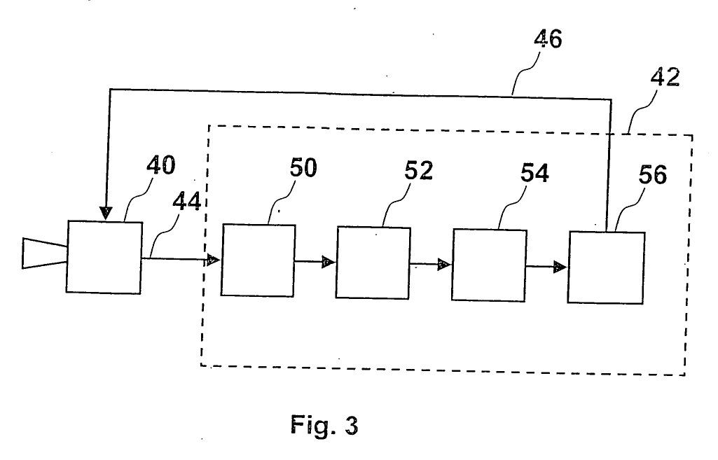

FIG. 3 shows a block diagram of the exemplary embodiment, made up of an image sensor 40 and a processing unit 42 having various modules 50, 52, 54, 56. In an exemplary embodiment, image sensor 40 is located behind the windshield of a motor vehicle in the area of the interior rearview mirror. In a variant of the exemplary embodiment, image sensor 40 is built into the bumper and/or a side mirror and/or the taillight. Image sensor 40 is aligned in such a way that the image capture zone includes at least part of the surroundings of the motor vehicle. In the exemplary embodiment, a black/white CMOS image sensor having a resolution of 640×480 pixels with 8-bit gray scale resolution is used as image sensor 40. Image sensor 40 has a freely configurable characteristic curve of the exposure sensitivity in linear segments, the number of segments and/or the position of the segments and/or the size of the individual segments and/or at least one parameter of the linear functions in a segment being adjustable. Alternatively or in addition, the gain and/or the offset and/or the integration time are adjusted. In the exemplary embodiment, the setting of the characteristic curve of the exposure sensitivity is adjusted jointly for all pixels of image sensor 40. Individual modules 50, 52, 54, 56 of processing unit 42 are implemented in the exemplary embodiment in a digital microprocessor, which implements the functions of modules 50, 52, 54, 56 described below as programs, subprograms, or program steps. In one variant there are at least two microprocessors, to which individual modules 50, 52, 54, 56 are distributed. Of course it is also possible to distribute the individual modules to discrete processing units with their own computing capabilities.

The image signals generated by image sensor 40 are transmitted over signal line 44 to processing unit 42. The image signals are transmitted electrically and/or optically and/or by radio. From the incoming image signals, i.e., the camera images, the histogram of the gray values is determined in histogram determination module 50. The histogram of the gray values indicates the frequency of the individual gray values of an image or image detail. In the exemplary embodiment, the histogram of the gray values is determined from an overall image. For each gray value, the associated illumination intensity is determined in freely definable, virtual units in histogram determination module 50 as a function of the parameters set, such as the gain and/or the offset and/or the integration time, and/or the parameters for adjusting the characteristic curve of the exposure sensitivity, such as the number of segments of the characteristic curve of the exposure sensitivity, and/or the position of the segments of the characteristic curve of the exposure sensitivity, and/or the size of the segments of the characteristic curve of the exposure sensitivity, and/or the at least one parameter of the linear functions.

In module 52 for determining the optimal characteristic curve, the optimal characteristic curve is calculated as a function of the histogram of the gray values determined in preceding histogram determination module 50. With N gray values in the histogram, having respective frequencies hⱼ and associated illumination intensities Φⱼ, the result is a table of N elements, whose entries i are calculated for example from

$${g}_{i} = \frac{{G}_{max}}{{ϕ}_{N}} \sum {h}_{j} ( {ϕ}_{j} - {ϕ}_{j - 1} ) where {Φ}_{0} = 0 , 1 \leq i \leq N$$

where Gₘₐₓ designates the maximum depictable gray value. The calculated function for mapping illumination intensities Φ on gray values g represents the optimal characteristic curve of the exposure sensitivity according to information theory for the given histogram, and is an optimal characteristic curve of the exposure sensitivity.

The optimal characteristic curve of the exposure sensitivity is distinguished basically by the fact that after adjustment of the characteristic curve of the exposure sensitivity of the image sensor, which is approximated to the determined optimal characteristic curve of the exposure sensitivity, the frequency of the individual gray values in the histogram of the image signals, i.e., of the camera image of the image sensor, is approximately constant, and/or the gray value density of the histogram of the image signals, i.e., of the camera image of the image sensor, is approximately constant. The frequency of a gray value here designates the number of pixels within the camera image that have this gray value based on the total number of pixels. A constant frequency of the gray values within a histogram of an image is referred to as a uniformly distributed histogram. The gray value density designates the sum of frequencies h(gᵢ) of gray values gᵢ in an interval Δg of gray values in reference to this interval Δg: (Σh(gᵢ))/Δg.

In module 54 for approximating the characteristic curve of the exposure sensitivity, the characteristic curve of the exposure sensitivity in linear segments of the pixels of the image sensor is now chosen so that it agrees as precisely as possible with the optimal characteristic curve obtained. In the exemplary embodiment, this is performed in module 54 for approximating the characteristic curve of the exposure sensitivity, through a numerical minimization of the quadratic separation between the optimal characteristic curve of the exposure sensitivity and the characteristic curve in linear segments, while varying the parameters.

Alternatively or in addition, in a variant of the exemplary embodiment, the segmenting method described in Hwa-Cho Yi: Sensordatenauswertung mit Fuzzy-Logik fuer das automatisierte Entgraten [Sensor data evaluation with fuzzy logic for automated deburring] (Munich: Hanser-Verlag, 1993, TU-Berlin dissertation, pp. 76-79) is used. This segmenting method operates according to the iterative final point method or the principle of the search for the longest segment. The determined parameters, such as the gain and/or the offset and/or the integration time and/or number of segments of the characteristic curve of the exposure sensitivity and/or the position of the segments of the characteristic curve of the exposure sensitivity and/or the size of the segments of the characteristic curve of the exposure sensitivity, and/or at least one parameter of the linear functions, are transmitted from module 54 for approximating the characteristic curve of the exposure sensitivity to module 56 for generating the adjustment signals.

In module 56 for generating the adjustment signals, the at least one corresponding adjustment signal is determined from the determined parameters, and the at least one adjustment signal is transmitted over signal line 46 electrically and/or optically and/or by radio to image sensor 40. In image sensor 40, the characteristic curve of the exposure sensitivity is adjusted as a function of at least one adjustment signal. In the exemplary embodiment, the characteristic curve of the exposure sensitivity takes effect in the image that follows determination of the optimal characteristic curve of the exposure sensitivity. Alternatively or in addition, in additional variants the characteristic curve of the exposure sensitivity takes effect in the same image and/or in the next image but one and/or in at least one additional image.

The use of the method according to the present invention and/or of the processing unit according to the present invention and/or of the computer program according to the present invention for adjusting the characteristic curve of the exposure sensitivity of at least one pixel of at least one image sensor becomes clear when the at least one image sensor receives an incoming image having a wedge of gray values, the wedge of gray values being made up of two segments having a different gradient of the gray values. In otherwise adjusted and/or controlled and/or regulated image sensors having a characteristic curve in linear segments, with variable overall illumination of the gray value wedge, an apparent contour caused by the bent characteristic curve of the exposure sensitivity appears, which does not agree with the segment boundary of the gray value wedge. In contrast, through the method according to the present invention and/or the processing unit according to the present invention and/or the computer program according to the present invention, this apparent contour will lie exactly on or at least very close to the separation line, even if the overall illumination is changed.

The described method and/or processing unit and/or computer program are not restricted to adjusting the characteristic curve of the exposure sensitivity of an image sensor in a motor vehicle. Rather, the described approach using the corresponding features is also usable outside of motor vehicle technology, moreover with more than one image sensor. Furthermore, the described method and/or processing unit and/or computer program is not restricted to adjusting the characteristic curve of the exposure sensitivity. Rather, the approach is also suitable in particular for controlling and/or regulating the characteristic curve of the exposure sensitivity.

In a variant of the described method and/or the processing unit and/or the computer program, the characteristic curve of the exposure sensitivity of at least one pixel of at least one image sensor is adjusted as a function of at least one image detail from at least one image sensor. A first embodiment includes the provision that the image segment is specifiable manually by at least one user, while in an additional embodiment the image detail is determined automatically by the processing unit.

Another variant contains the provision, alternatively or in addition, that the characteristic curve of the exposure sensitivity of at least one pixel of at least one image sensor is adjusted as a function of image signals, in particular of at least one image and/or at least one image detail, from at least two or more image sensors. Alternatively or in addition, the adjustment of the characteristic curve of the exposure sensitivity of at least one pixel of at least one image sensor is performed as a function of image signals from at least one stereo camera. The stereo camera is made up here of at least two image sensors, which record essentially the same scene. For example, a common histogram of the gray values is calculated here from the images and/or image details and is used to determine the optimal characteristic curve of the exposure sensitivity.

In general, the described procedure is not restricted to a black/white CMOS image sensor having a resolution of 640×480 pixels with 8-bit gray scale resolution. Rather, the method and/or the processing unit and/or the computer program are suitable for all types of image sensors. The only prerequisite is that the image sensors have a configurable characteristic curve of the exposure sensitivity, having segments with functions, in particular continuous and/or linear functions. For example, in one variant a CCD image sensor is used. In another variant, alternatively or in addition, an image sensor having a logarithmic characteristic curve in segments is used. In addition, the described approach using the corresponding features is also usable with at least one color image sensor. Alternatively or in addition, in another variant the characteristic curve of the exposure sensitivity of at least one pixel of at least one image sensor is adjusted.

1-14. (canceled)

15. A method for adjusting a characteristic curve of an exposure sensitivity of at least one pixel of at least one image sensor, in a motor vehicle, the characteristic curve being formed in segments of functions, the method comprising:
adjusting the characteristic curve of the exposure sensitivity as a function of image signals from at least a part of the scene registered by the at least one image sensor so that at least one of the following is satisfied: a frequency of the gray values of at least a part of the histogram of image signals from the at least one image sensor of the at least one part of the registered scene is approximately constant; and the gray value density of at least a part of the histogram of image signals from the at least one image sensor of the at least one part of the registered scene is approximately constant.

16. The method of claim 15, wherein the characteristic curve of the exposure sensitivity is adjusted as a function of image signals from at least a part of the scene registered by the at least one image sensor, so that, when a gray value wedge having two segments with different gradients of the gray values is registered as the scene, the at least one image sensor generates an image nearly free of apparent contours.

17. The method of claim 15, wherein the characteristic curve of the exposure sensitivity is adjusted as a function of a determined optimal characteristic curve of the exposure sensitivity, including a determined characteristic curve of the exposure sensitivity which is optimal according to information theory, at least one of the optimal characteristic curve of the exposure sensitivity and the characteristic curve of the exposure sensitivity which is optimal according to information theory being determined as a function of image signals from the at least one image sensor.

18. The method of claim 17, further comprising:
determining the optimal characteristic curve of the exposure sensitivity as a function of a histogram of the gray values of at least one image and/or of at least one image detail;
approximating the characteristic curve of the exposure sensitivity to the determined optimal characteristic curve of the exposure sensitivity, including approximation of the characteristic curve of the exposure sensitivity to the determined optional characteristic curve of the exposure sensitivity through at least one numerical approximation method and/or at least one segmenting method.

19. The method of claim 15, wherein at least one of the gain, the offset, the integration time and at least one additional parameter for adjusting the characteristic curve of the exposure sensitivity of the at least one pixel of the at least one image sensor is adjusted, the at least one additional parameter for adjusting the characteristic curve of the exposure sensitivity being at least one of (i) at least one parameter for adjusting the number of segments of the characteristic curve of the exposure sensitivity, (ii) at least one parameter for adjusting the position of the segments of the characteristic curve of the exposure sensitivity, (iii) at least one parameter for adjusting the size of the segments of the characteristic curve of the exposure sensitivity, and (iv) at least one parameter for adjusting the at least one function.

20. The method of claim 15, wherein at least one of the functions is a linear function.

21. The method of claim 15, wherein the characteristic curve of the exposure sensitivity of the at least one pixel of the at least one image sensor is adjusted as a function of image signals from at least two image sensors, including at least one stereo camera.

22. A processing unit for generating at least one adjustment signal for adjusting the characteristic curve of the exposure sensitivity of at least one pixel of at least one image sensor, including in a motor vehicle, the characteristic curve being formed in segments of functions, including of linear functions, comprising:
an arrangement to generate the at least one adjustment signal to adjust the characteristic curve of the exposure sensitivity as a function of image signals from at least a part of the scene registered by the at least one image sensor so that at least one of a frequency of the gray values of at least a part of the histogram of image signals from the at least one image sensor of the at least one part of the registered scene is approximately constant, and a gray value density of at least a part of the histogram of image signals from the at least one part of the registered scene is approximately constant.

23. The processing unit of claim 22, wherein the processing unit generates the at least one adjustment signal to adjust the characteristic curve of the exposure sensitivity as a function of image signals from at least a part of the scene registered by the at least one image sensor, so that, when a gray value wedge having two segments with different gradients of the gray values is registered as the scene, the at least one image sensor generates an image nearly free of apparent contours.

24. The processing unit of claim 22, wherein the processing unit adjusts the characteristic curve of the exposure sensitivity as a function of a determined optimal characteristic curve of the exposure sensitivity, including a determined characteristic curve of the exposure sensitivity which is optimal according to information theory, the processing unit determining at least one of the optimal characteristic curve of the exposure sensitivity and the characteristic curve of the exposure sensitivity which is optimal according to information theory as a function of image signals from the at least one image sensor.

25. The processing unit of claim 24, wherein the processing unit performs at least one of the following:
determines the optimal characteristic curve of the exposure sensitivity as a function of a histogram of the gray values of at least one image and/or of at least one image detail; and
approximates the characteristic curve of the exposure sensitivity to the determined optimal characteristic curve of the exposure sensitivity, including that the processing unit approximates the characteristic curve of the exposure sensitivity to the determined optimal characteristic curve of the exposure sensitivity by at least one of numerical approximation methods and segmenting methods.

26. The processing unit of claim 22, wherein the processing unit generates at least one adjustment signal for adjusting at least one of the gain, the offset, the integration time and at least one additional adjustment signal for adjusting the characteristic curve of the exposure sensitivity of the at least one pixel of the at least one image sensor, and wherein the at least one additional adjustment signal for adjusting the characteristic curve of the exposure sensitivity is at least one of (i) at least one adjustment signal for adjusting the number of segments of the characteristic curve of the exposure sensitivity, (ii) at least one adjustment signal for adjusting the position of the segments of the characteristic curve of the exposure sensitivity, (iii) at least one adjustment signal for adjusting the size of the segments of the characteristic curve of the exposure sensitivity, and (iv) at least one adjustment signal for adjusting the at least one function.

27. The processing unit of claim 22, wherein the processing unit generates the at least one adjustment signal for adjusting the characteristic curve of the exposure sensitivity of the at least one pixel of the at least one image sensor as a function of image signals from at least two image sensors, including at least one stereo camera.

28. A computer program executable on a computer, comprising:
a program code arrangement for adjusting a characteristic curve of an exposure sensitivity of at least one pixel of at least one image sensor, in a motor vehicle, the characteristic curve being formed in segments of functions, by performing the following:
adjusting the characteristic curve of the exposure sensitivity as a function of image signals from at least a part of the scene registered by the at least one image sensor so that at least one of the following is satisfied: a frequency of the gray values of at least a part of the histogram of image signals from the at least one image sensor of the at least one part of the registered scene is approximately constant; and the gray value density of at least a part of the histogram of image signals from the at least one image sensor of the at least one part of the registered scene is approximately constant.

29. The computer program of claim 28, wherein the characteristic curve of the exposure sensitivity is adjusted as a function of image signals from at least a part of the scene registered by the at least one image sensor, so that, when a gray value wedge having two segments with different gradients of the gray values is registered as the scene, the at least one image sensor generates an image nearly free of apparent contours.

30. The computer program of claim 28, wherein the characteristic curve of the exposure sensitivity is adjusted as a function of a determined optimal characteristic curve of the exposure sensitivity, including a determined characteristic curve of the exposure sensitivity which is optimal according to information theory, at least one of the optimal characteristic curve of the exposure sensitivity and the characteristic curve of the exposure sensitivity which is optimal according to information theory being determined as a function of image signals from the at least one image sensor.

31. The computer program of claim 30, further comprising:
determining the optimal characteristic curve of the exposure sensitivity as a function of a histogram of the gray values of at least one image and/or of at least one image detail;
approximating the characteristic curve of the exposure sensitivity to the determined optimal characteristic curve of the exposure sensitivity, including approximation of the characteristic curve of the exposure sensitivity to the determined optional characteristic curve of the exposure sensitivity through at least one numerical approximation method and/or at least one segmenting method.

32. The computer program of claim 28, wherein at least one of the gain, the offset, the integration time and at least one additional parameter for adjusting the characteristic curve of the exposure sensitivity of the at least one pixel of the at least one image sensor is adjusted, the at least one additional parameter for adjusting the characteristic curve of the exposure sensitivity being at least one of (i) at least one parameter for adjusting the number of segments of the characteristic curve of the exposure sensitivity, (ii) at least one parameter for adjusting the position of the segments of the characteristic curve of the exposure sensitivity, (iii) at least one parameter for adjusting the size of the segments of the characteristic curve of the exposure sensitivity, and (iv) at least one parameter for adjusting the at least one function.

33. The computer program of claim 28, wherein at least one of the functions is a linear function.

34. The computer program of claim 28, wherein the characteristic curve of the exposure sensitivity of the at least one pixel of the at least one image sensor is adjusted as a function of image signals from at least two image sensors, including at least one stereo camera.
